(19) United States
(12) Patent Application Publication
(10) Pub. No.: US 2024/0213604 A1
(43) Pub. Date: Jun. 27, 2024

(54) BATTERY MODULE

(71) Applicant: HONDA MOTOR CO., LTD., Tokyo (JP)

(72) Inventors: Yosuke YOSHIZAWA, Saitama (JP); Hidemasa USUI, Saitama (JP); Takeo FUJII, Saitama (JP)

(21) Appl. No.: 18/395,763

(22) Filed: Dec. 26, 2023

(30) Foreign Application Priority Data
Dec. 27, 2022 (JP) 2022-210299

(51) Int. Cl. H01M 50/242; H01M 50/204; H01M 50/291; H01M 50/293

(52) U.S. Cl. CPC H01M 50/242; H01M 50/204; H01M 50/291; H01M 50/293

(57) ABSTRACT

Provided is a battery module including a battery cell stack in which a plurality of battery cells are stacked, a pair of plate-shaped members provided at both ends of the battery cell stack in a stacking direction, and a cushioning material disposed between the plurality of battery cells and/or between the battery cell stack and one of the plate-shaped members. The cushioning material includes a pair of first elastic members arranged on both outer sides in the stacking direction of the battery cell stack, a second elastic member disposed between the pair of first elastic members, and a rigid member disposed between one of the first elastic members and the second elastic member.

This application is based on and claims the benefit of priority from Japanese Patent Application No. 2022-210299, filed on 27 Dec. 2022, the content of which is incorporated herein by reference.

### BACKGROUND OF THE INVENTION

### Field of the Invention

The present invention relates to a battery module.

### Related Art

In recent years, research and development have been carried out on secondary batteries that contribute to energy efficiency in order to ensure that many people have access to affordable, reliable, sustainable, and advanced energy. Since battery cells expand and contract as they are charged and discharged, the battery module includes, for example, a pair of end plates provided at both ends of the battery cell stack in the stacking direction, and a binding bar that restrains the battery cell stack between the pair of end plates.

However, all-solid-state battery cells undergo large volume changes due to expansion and contraction during charging and discharging, which changes the dimensions of the battery module, making it difficult to mount the battery module in a vehicle.

Patent Document 1 discloses an assembled battery in which gap adjustment units are intermittently arranged between all-solid-state battery cells. Here, the gap adjustment unit has an elastic body disposed between a pair of plates.

### CITATION LIST

### Patent Document

Patent Document 1: Japanese Unexamined Patent Application, Publication No. 2020-77500

### SUMMARY OF THE INVENTION

However, there is room for improvement in the energy density of the battery module.

For example, it is conceivable to use a cushioning material in which a second elastic member is disposed between a pair of first elastic members in order to further absorb expansion and contraction of the all-solid-state battery cells during charging and discharging.

However, when the cushioning material is compressed due to expansion of the all-solid-state battery cells during charging, the difference in surface pressure between the portion of the first elastic member that is in contact with the second elastic member and the portion of the first elastic member that is not in contact with the second elastic member may become large, and the uniformity of the surface pressure of the cushioning material may become low.

An object of the present invention is to provide a battery module capable of increasing energy density and the uniformity of the surface pressure of a cushioning material.
(1) A first aspect is a battery module including a battery cell stack in which a plurality of battery cells are stacked, a pair of plate-shaped members provided at both ends of the battery cell stack in a stacking direction, and a cushioning material disposed between the plurality of battery cells and/or between the battery cell stack and one of the plate-shaped members. The cushioning material includes a pair of first elastic members arranged on both outer sides in the stacking direction of the battery cell stack, a second elastic member disposed between the pair of first elastic members, and a rigid member disposed between one of the first elastic members and the second elastic member.
(2) In a second aspect according to the first aspect, the second elastic member has a recess or a through hole.
(3) In a third aspect according to the second aspect, the recess or the through hole has a diameter of 4 mm or less.
(4) In a fourth aspect according to any one of the first to third aspects, the rigid member has a Poisson's ratio of 0.3 or less.
(5) In a fifth aspect according to the fourth aspect, the rigid member includes stainless steel.
(6) In a sixth aspect according to any one of the first to fifth aspects, the battery cells are solid-state battery cells.

According to the present invention, it is possible to provide a battery module capable of increasing energy density and the uniformity of the surface pressure of a cushioning material.

### BRIEF DESCRIPTION OF THE DRAWINGS

FIG. 1 is a sectional view showing an example of a battery module of the present embodiment;

FIG. 2 is a partially exploded perspective view showing a cushioning material in FIG. 1;

FIG. 3 is a sectional view showing a state in which a cushioning material is compressed when a rigid member is not disposed between a foam body and a honeycomb structure;

FIG. 4 is a side view showing a modification of the cushioning material in FIG. 2; and

FIG. 5 is a side view showing a modification of the cushioning material in FIG. 2.

### DETAILED DESCRIPTION OF THE INVENTION

Hereinafter, embodiments of the present invention will be described with reference to the drawings.

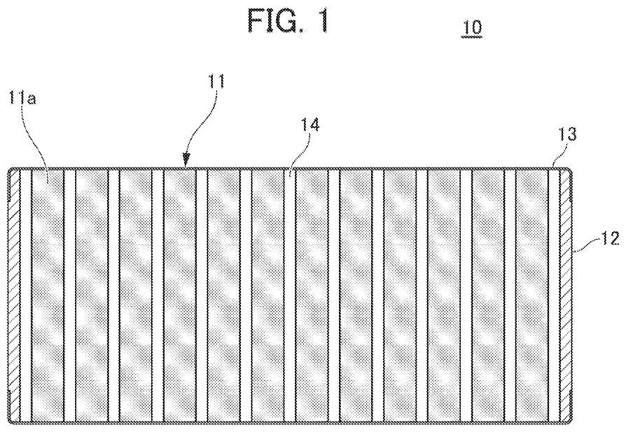

FIG. 1 shows an example of a battery module of the present embodiment.

A battery module 10 includes a battery cell stack 11 in which a plurality of battery cells 11a are stacked, end plates 12 as a pair of plate-shaped members provided at both ends of the battery cell stack 11 in the stacking direction, and binding bars 13 as restraining members for restraining the battery cell stack 11 between the pair of end plates 12. Here, the binding bars 13 are provided at two locations, that is, an upper portion and a lower portion in the drawing.

In the battery module 10, cushioning materials 14 are arranged between the plurality of battery cells 11a and between the battery cell stack 11 and each of the end plates 12.

The cushioning materials 14 may be arranged between the plurality of battery cells 11a or between the battery cell stack 11 and each of the end plates 12.

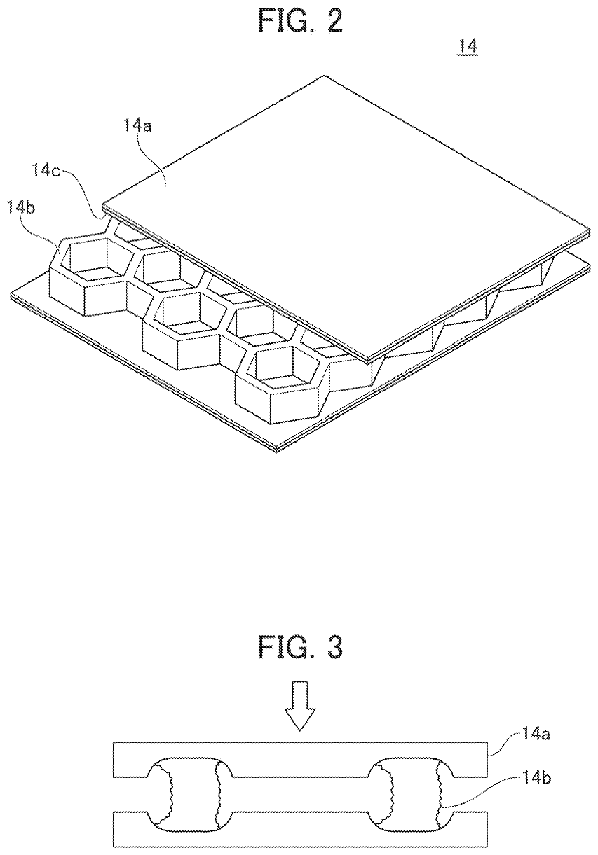

As shown in FIG. 2, the cushioning material 14 includes foam bodies 14a as a pair of first elastic members arranged on both outer sides in the stacking direction of the battery cell stack 11, a honeycomb structure 14b as a second elastic member disposed between the pair of foam bodies 14a, and a rigid member 14c disposed between each of the foam bodies 14a and the honeycomb structure 14b.

Here, when the cushioning material 14 is compressed due to expansion of the battery cell 11a during charging, since the rigid member 14c is disposed between the foam body 14a and the honeycomb structure 14b, the difference in surface pressure between the portion of the foam body 14a that is in contact with the honeycomb structure 14b and the portion of the foam body 14a that is not in contact with the honeycomb structure 14b is reduced, and the uniformity of surface pressure is increased.

On the other hand, if the rigid member 14c is not disposed between the foam body 14a and the honeycomb structure 14b, when the cushioning material is compressed, only the portions of the foam body 14a that are in contact with the honeycomb structure 14b may be compressed (see FIG. 3). As a result, the difference in surface pressure between the portions of the foam body 14a that are in contact with the honeycomb structure 14b and the portions of the foam body 14a that are not in contact with the honeycomb structure 14b is increased, and the uniformity of surface pressure is reduced. This tendency is significant when the thickness of the foam body 14a is small, that is, when the energy density of the battery module 10 is high.

The Poisson's ratio of the first elastic member is preferably 0.3 or less. When the Poisson's ratio of the first elastic member is 0.3 or less, the first elastic member can easily absorb changes in thickness due to expansion and contraction of the battery cell 11a. The Poisson's ratio of the first elastic member is not limited, but is, for example, 0 or more.

The spring constant per unit area of the second elastic member is preferably 0.9 MPa/mm or more. When the spring constant per unit area of the second elastic member is 0.9 MPa/mm or more, the energy density of the battery module 10 increases. The spring constant per unit area of the second elastic member is not limited, but is, for example, 2.0 MPa/mm or less.

The porosity of the foam body 14a is not limited, but is, for example, 30% or more and 95% or less.

The thickness of the foam body 14a at 100% SOC is not limited, but is, for example, 0.07 mm or more and 0.5 mm or less.

The material constituting the foam body 14a is not limited, but examples thereof include polyurethane, silicone resin, ethylene propylene rubber, styrene resin, olefin resin, polyamide, and polyester.

The porosity of the honeycomb structure 14b is preferably 78% or more. When the porosity of the honeycomb structure 14b is 78% or more, the honeycomb structure 14b can easily absorb changes in thickness due to expansion and contraction of the battery cells 11a. The porosity of the honeycomb structure 14b is not limited, but is, for example, 48% or more and 90% or less.

The thickness of the honeycomb structure 14b at 100% SOC is not limited, but is, for example, 0.5 mm or more and 1.0 mm or less.

The material constituting the honeycomb structure 14b is not limited, but examples thereof include rubbers such as silicone rubber (VMQ), ethylene propylene diene rubber (EPDM), fluoro rubber (FKM), nitrile rubber (NBR), hydrogenated nitrile rubber (HNBR), chloroprene rubber (CR), acrylic rubber (ACM), butyl rubber (IIR), urethane rubber (U), chlorosulfonated polyethylene rubber (CSM), and epichlorohydrin rubber (ECO).

The Young's modulus of the rigid member 14c is preferably 150 GPa or more. When the Young's modulus of the rigid member is 150 GPa or more, the uniformity of the surface pressure of the cushioning material 14 increases. The Young's modulus of the rigid member 14c is not limited, but is, for example, 35 GPa or more and 210 GPa or less.

The material constituting the rigid member 14c is not limited, but examples thereof include stainless steel.

As the second elastic member, a member having recesses or through holes other than the honeycomb structure 14b may be used. The member having recesses or through holes can be manufactured, for example, using a mold, a 3D printer, or a precision water jet. The cross-sectional shape of the recess or the through hole may be triangular, quadrangular, etc., in addition to hexagonal.

The diameter of the recess or the through hole is preferably 4 mm or less. When the diameter of the recess or the through hole is 4 mm or less, the uniformity of the surface pressure of the cushioning material 14 increases. The diameter of the recess or the through hole is not limited, but is, for example, 2 mm or more.

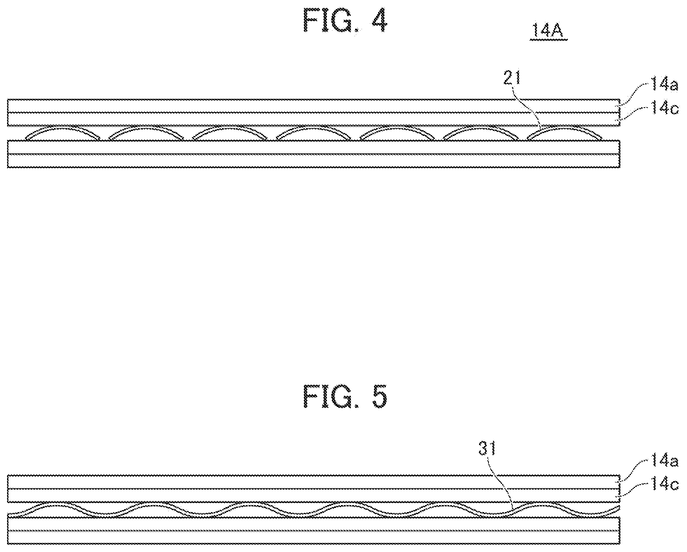

FIG. 4 shows a modification of the cushioning material 14.

A cushioning material 14A is the same as the cushioning material 14 except that a member in which a plurality of arc-shaped leaf springs 21 are arranged in parallel is disposed as the second elastic member between the pair of foam bodies 14a.

The Young's modulus of the leaf spring 21 is preferably 35 GPa or more. When the Young's modulus of the leaf spring 21 is 35 GPa or more, the leaf springs 21 can easily absorb changes in thickness due to expansion and contraction of the battery cells 11a. The Young's modulus of the leaf spring 21 is not limited, but is, for example, 200 GPa or less.

The material constituting the leaf spring 21 is not limited, but examples thereof include metals such as stainless steel and carbon steel, resins such as epoxy resins, phenol resins, and nylon resins, and fiber reinforced plastics (FRP).

As the second elastic member, a member having a leaf spring structure other than the member in which a plurality of arc-shaped leaf springs 21 are arranged in parallel may be used. For example, instead of arranging a plurality of arc-shaped leaf springs 21 in parallel, a wave-shaped leaf spring 31 (see FIG. 5) may be arranged. This facilitates manufacturing of the cushioning material.

The battery cell 11a is not limited, but examples thereof include solid-state battery cells such as all-solid-state lithium ion battery cells and all-solid-state lithium metal battery cells, and lithium metal battery cells. Among them, a solid-state battery cell is preferable.

Hereinafter, a case where the battery cell 11a is an all-solid-state lithium metal battery cell will be described.

In the all-solid-state lithium metal battery cell, for example, a positive electrode current collector, a positive electrode material mixture layer, a solid electrolyte layer, a lithium metal layer, and a negative electrode current collector are sequentially laminated.

The positive electrode current collector is not limited, but examples thereof include aluminum foil.

The positive electrode material mixture layer includes a positive electrode active material, and may further include a solid electrolyte, a conductivity aid, a binder, and the like.

The positive electrode active material is not limited as long as it can occlude and release lithium ions. Examples thereof include LicoO₂, Li(N_{15/10}CO_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}CO_{0.15}Al_{0.05})O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LiFePO₄, lithium sulfide, and sulfur.

The solid electrolyte constituting the solid electrolyte layer is not limited as long as it is a material capable of conducting lithium ions, and examples thereof include an oxide electrolyte and a sulfide electrolyte.

The negative electrode current collector is not limited, but examples thereof include copper foil.

Although embodiments of the present invention have been described above, the present invention is not limited to the above-described embodiments, and the above-described embodiments may be modified as appropriate within the scope of the intent of the present invention.

### EXAMPLES

Hereinafter, examples of the present invention will be described, but the present invention is not limited to these examples.

### Example 1

A cushioning material 14 (see FIG. 2) was produced by using a plate-shaped member made of polyurethane having a thickness of 0.14 mm as a foam body 14a, a plate-shaped member made of silicone rubber having a thickness of 2.8 mm and a through-hole diameter of 4 mm as a honeycomb structure 14b, and a plate-shaped member made of stainless steel having a thickness of 0.1 mm as a rigid member 14c.

### Example 2

A cushioning material was produced in the same manner as in Example 1 except that a plate-shaped member made of polyurethane having a thickness of 0.28 mm were used as the foam body 14a.

### Example 3

A cushioning material was produced in the same manner as in Example 1 except that a plate-shaped member made of polyurethane having a thickness of 0.70 mm were used as the foam body 14a.

### Comparative Example 1

A cushioning material was produced in the same manner as in Example 3 except that the rigid member 14c was not used.

### Comparative Example 2

A cushioning material was produced in the same manner as in Example 1 except that a plate-shaped member made of polyurethane having a thickness of 4 mm were used as the foam body 14a, and the rigid member 14c was not used.

### Comparative Example 3

A plate-shaped member made of polyurethane having a thickness of 4 mm were used as a cushioning material.

### [Uniformity of the Surface Pressure of the Cushioning Material]

After the cushioning material was placed on a sensor sheet of a pressure distribution measuring system (tactile sensor system) (manufactured by NITTA), a surface pressure of 1.5 MPa was applied to the entire surface of the cushioning material to obtain an area ratio of regions where the surface pressure was 1 MPa or more, and the uniformity of the surface pressure of the cushioning material was evaluated.

Table 1 shows evaluation results of the uniformity of the surface pressure of the cushioning material.

TABLE 1

| | | | | Comparative | Comparative | Comparative |
|---|---|---|---|---|---|---|
| | Example 1 | Example 2 | Example 3 | Example 1 | Example 2 | Example 3 |
| THICKNESS OF FOAM | 0.14 | 0.28 | 0.70 | 0.70 | 4 | 4 |
| BODY [mm] | | | | | | |
| HONEYCOMB STRUCTURE | PRESENCE | PRESENCE | PRESENCE | PRESENCE | PRESENCE | ABSENCE |
| RIGID MEMBER | PRESENCE | PRESENCE | PRESENCE | ABSENCE | ABSENCE | ABSENCE |
| AREA RATIO OF REGIONS | 66 | 82 | 90 | 50 | 90 | 95 |
| WHERE SURFACE | | | | | | |
| PRESSURE IS 1 MPa OR | | | | | | |
| MORE [%] | | | | | | |

Table 1 shows that the cushioning materials of Examples 1 to 3 have high uniformity of surface pressure. Furthermore, regarding the cushioning materials of Examples 1 to 3, since the thickness of the foam body is small, the energy density of the battery module is increased.

On the other hand, regarding the cushioning material of Comparative Example 1, since the rigid member is not used, the uniformity of the surface pressure is low. Regarding the cushioning materials of Comparative Examples 2 and 3, since the thickness of the foam body is large, the energy density of the battery module is low.

### EXPLANATION OF REFERENCE NUMERALS

10 battery module
11 battery cell stack
11a battery cell
12 end plate
13 binding bar
14 cushioning material
14a foam body
14b honeycomb structure
14c rigid member
21 leaf spring
31 wave-shaped leaf spring

What is claimed is:

1. A battery module, comprising:
a battery cell stack in which a plurality of battery cells are stacked;
a pair of plate-shaped members provided at both ends of the battery cell stack in a stacking direction; and
a cushioning material disposed between the plurality of battery cells and/or between the battery cell stack and one of the plate-shaped members,
the cushioning material comprising a pair of first elastic members arranged on both outer sides in the stacking direction of the battery cell stack, a second elastic member disposed between the pair of first elastic members, and a rigid member disposed between one of the first elastic members and the second elastic member.

2. The battery module according to claim 1, wherein the second elastic member has a recess or a through hole.

3. The battery module according to claim 2, wherein the recess or the through hole has a diameter of 4 mm or less.

4. The battery module according to claim 1, wherein the rigid member has a Poisson's ratio of 0.3 or less.

5. The battery module according to claim 4, wherein the rigid member comprises stainless steel.

6. The battery module according to claim 1, wherein the battery cells are solid-state battery cells.
